(19) United States
(12) Patent Application Publication
(10) Pub. No.: US 2024/0291847 A1
(43) Pub. Date: Aug. 29, 2024

(54) SECURITY RISK REMEDIATION TOOL

(71) Applicant: FEROOT SECURITY INC., Toronto (CA)

(72) Inventors: Ivan Tsarynny, Toronto (CA); Vitaliy Lim, Toronto (CA)

(73) Assignee: FEROOT SECURITY INC., Toronto, ON (CA)

(21) Appl. No.: 18/573,976

(22) PCT Filed: Jun. 23, 2022
(86) PCT No.: PCT/CA2022/051017

§ 371 Date: Dec. 22, 2023

Related U.S. Application Data
(60) Provisional application No. 63/214,363, filed on Jun. 24, 2021.

(51) Int. Cl. H04L 9/40

(52) U.S. Cl. CPC H04L 63/1433

(57) ABSTRACT

A method including generating scan results by executing a scan by a server web browser. The scan includes a behavior pattern that defines a simulated use of the server web browser to access a web service. Executing the scan includes causing the server web browser to access the web service according to the behavior pattern. The scan results include monitoring information generated by monitoring execution of the scan. The method also includes detecting, using the scan results, a vulnerability of data accessed during the simulated use of the server web browser. The method also includes determining, responsive to detecting the vulnerability, an access mode for the data. The method also includes applying the access mode to an attempt to access the data by the server web browser.

### CROSS-REFERENCE TO RELATED APPLICATIONS

This application claims priority to U.S. Provisional Patent Application No. 63/214,363, filed Jun. 24, 2021. U.S. Provisional Patent Application No. 63/214,363 is incorporated herein by reference in its entirety.

### BACKGROUND

Cybersecurity is an increasingly important field, as malicious users continuously find new techniques for stealing sensitive information and/or injecting malware on a victim's computing system. For example, client-side cyberattacks (such as drive-by skimming attacks, side loading attacks, cross-site scripting attacks, and chain loading attacks) can sidestep web application firewalls and steal sensitive information directly from client user devices during a browser session with a legitimate web service. While the legitimate web service may be well protected against direct cyberattacks, a malicious user can bypass the protections of the web service using such client-side cyberattacks. The company hosting the web service may not be able to defend against such client-side cyberattacks.

### SUMMARY

The one or more embodiments provide for a method. The method includes generating scan results by executing a scan by a server web browser. The scan includes a behavior pattern that defines a simulated use of the server web browser to access a web service. Executing the scan includes causing the server web browser to access the web service according to the behavior pattern. The scan results include monitoring information generated by monitoring execution of the scan. The method also includes detecting, using the scan results, a vulnerability of data accessed during the simulated use of the server web browser. The method also includes determining, responsive to detecting the vulnerability, an access mode for the data. The method also includes applying the access mode to an attempt to access the data by the server web browser.

The one or more embodiments provide for another method. The method includes receiving, from client applications including client web browsers executing in runtime environments, requests to access or to transmit data to a web service. The method also includes generating browser sessions for the client web browsers. The method also includes applying security configurations to the browser sessions. The security configurations includes a selected access mode applicable to scripts executable by the client web browsers in the runtime environments. The method also includes monitoring for a call to execute, in a runtime environment of the runtime environments, a script of the scripts during a browser session of the browser sessions. The method also includes securing the data by applying the selected access mode to the script before permitting the script to execute in the runtime environment.

The one or more embodiments also provide for a system. The system includes a server and a repository in communication with the server. The repository stores data including sensitive information. The repository also stores requests to access or to transmit the data to a web service, the requests received from client applications including client web browsers executing in runtime environments. The repository also stores security configurations applicable to browser sessions generated for the client web browsers. The security configurations include a selected access mode applicable to scripts executable by the client web browsers in the runtime environments. The system also includes the web service. The web service is executable by or in communication with the server, and is programmed to receive, from the client applications, the requests to access or to transmit the data to the web service.

The web service is also programmed to generate the browser sessions. The system also includes a script analysis controller executable by the server and programmed to apply the security configurations to the browser sessions. The script analysis controller is further programmed to monitor for a call to execute, in a runtime environment of the runtime environments, a script of the scripts during a browser session of the browser sessions. The script analysis controller is further programmed to secure the data by applying the selected access mode to the script before permitting the script to execute in the runtime environment.

Other aspects of the one or more embodiments will be apparent from the following description and the appended claims.

### BRIEF DESCRIPTION OF DRAWINGS

FIG. 1 shows a computing system, in accordance with one or more embodiments.

FIG. 2, FIG. 3, FIG. 4, FIG. 5, FIG. 6, and FIG. 7 show flowcharts, in accordance with one or more embodiments.

FIG. 8 shows a workflow, in accordance with one or more

embodiments.

FIG. 9 shows a pictorial representation of defending a client-side web page, in accordance with one or more embodiments.

FIG. 10 shows an example of a threat model, in accordance with one or more embodiments.

FIG. 11 shows an example of a surface report, in accordance with one or more embodiments.

FIG. 12A and FIG. 12B show an example of a computing system and a network environment, in accordance with one or more embodiments.

### DETAILED DESCRIPTION

Specific embodiments will now be described in detail with reference to the accompanying figures. Like elements in the various figures are denoted by like reference numerals for consistency.

In the following detailed description of embodiments, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description.

In general, the one or more embodiments related to improved cybersecurity. In particular, the one or more embodiments are directed to improving the defenses of a web service against client-side cyberattacks. Client-side cyberattacks are cyberattacks in which the client-side device, rather than server-side device, is the subject of attack by the malicious code. Examples client-side attacks include drive-by skimming attacks, JAVASCRIPT® library attacks, side loading attacks, chain loading attacks, cloud-hosted skimming attacks, and others.

The one or more embodiments contemplate at least two improved cyber security defenses. First, the one or more embodiments use a combination of simulated users and machine learning to probe the behaviors of a legitimate web service in order to find vulnerabilities in the legitimate web service. The one or more embodiments then improve the cybersecurity of the legitimate web service against client-side cyberattacks. Second, the one or more embodiments provide for continuous monitoring of and defense against client-side cyberattacks. In other words, the one or more embodiments permit a legitimate web service to help protect a client device against a client-side cyberattack during a browser session with the legitimate web service. Specifically, the one or more embodiments check for the execution of scripts in the execution environment of client-side web browsers, and interrupt execution of the scripts if execution of the scripts represents a security vulnerability.

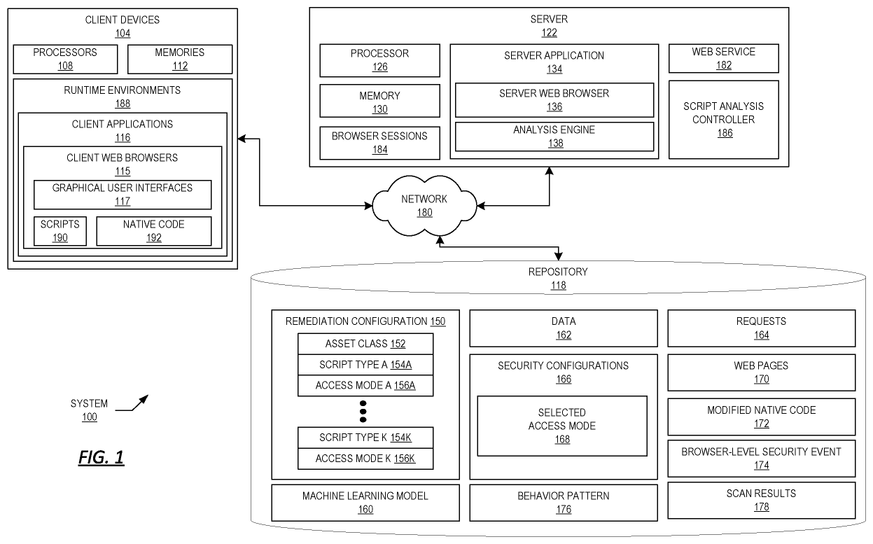

Attention is now turned to the figures. FIG. 1 shows a computing system, in accordance with one or more embodiments.

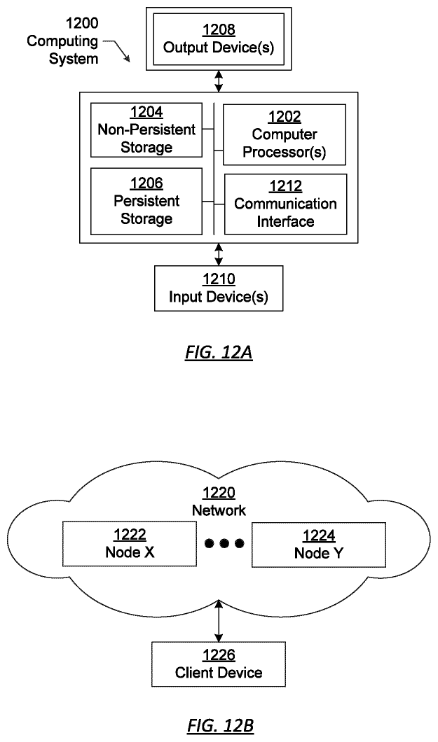

The system (100) remediates security risks. The system (100) includes client devices (104), a repository (118), and a server (122). The client devices (104) are one or more computing devices in accordance with the computing system (1200) and the nodes (1222) and (1224) described below in FIG. 12A and FIG. 12B. The client devices (104) includes corresponding memories (112) and processors (108) that execute and store applications to access the server (122) and present information to a user. In one or more embodiments, the client devices (104) are multiple client devices that access the server (122).

The processors (108) execute programs in the memories (112). In one or more embodiments, the processors (108) each represent multiple processors (e.g., processor(s) (1202) of FIG. 12A) that execute programs and communicate with the server (122).

The memories (112) store data and programs that are used and executed by the processors (108). In one or more embodiments, the memories (112) each represent multiple memories (e.g., non-persistent storage (1204) and/or persistent storage (1206) of FIG. 12A) that store data and programs that are used and executed by the processors (108). The memories (112) include corresponding client applications (116). The client applications (116) may be stored and executed on different memories and processors within the client devices (102).

The client applications (116) include one or more applications formed from one or more programs of the client devices (104) that are executed by the processors (108) and stored in the memories (112). In one or more embodiments, the programs are written in languages, including one or more of: assembly language, ANSI C, C++, Python, JAVA®, JAVASCRIPT®, extensible markup language (XML), hypertext markup language (HTML), cascading style sheets (CSS), Structured Query Language (SQL), Predictive Modeling Markup Language (PMML), etc. The client applications (116) may include graphical user interfaces (117). (The “graphical user interfaces” may also be referred-to as “GUIs”). In one or more embodiments, the client applications (116) in the memories (112) execute on the processors (108) of the client devices (104) to access the server application (134) of the server (122).

The client applications (116) may be desktop applications, mobile native applications, mobile web applications, etc. For example, the client applications (116) may include a web browser that accesses a web page that is hosted by the server (122) using the server application (134) to access a security risk monitoring tool. In another example, the client applications (116) are services that communicates with the server application (134) using a representational state transfer application programming interface (RESTful API) to access the security risk monitoring tool.

In one or more embodiments, the repository (118) is a computing system that may include multiple computing devices in accordance with the computing system (1200) and the nodes (1222) and (1224) described below in FIG. 12A and FIG. 12B. The repository (118) may be hosted by a cloud service provider. In one or more embodiments, the data in the repository (118) includes one or more versions of user information, behavior patterns and custom scenarios, remediation configurations (e.g., remediation configuration (150)), machine learning models (e.g., machine learning model (160)), logs, and reports. The data in the repository (118) may be processed by programs executing on the server (122) as described below. In one or more embodiments, the repository (118) is hosted by the same cloud services provider as the server (122).

The user information may include personally identifying information (name, address, etc.) and include account information (credit card number, website user name and password, etc.). The behavior patterns may include one or more actions. For example, the actions may be user initiated browser events, including mouse clicks, text entry, etc.

Each custom scenario includes a series of behavior patterns. For example, the series of behavior patterns may exercise one or more specific states of the client applications (116). Continuing this example, a custom scenario may include a series of behavior patterns that add an item to a cart of the client applications (116) so that a checkout action is enabled on a checkout page of the client applications (116). As another example, a custom scenario may fill out a form with a valid email address and/or a valid postal mailing address in order to enable other actions of the client applications (116). Additional information on custom scenarios is provided below.

A remediation configuration (150) includes, for an asset class (152), access modes (156A, 156K) corresponding to script types (154A, 154K). An asset class (152) is a category of data collected (e.g., ingested) by the client applications (116). For example, the asset class may be a password, a date of birth, an email address, a company name, etc. The asset class (152) may specify an object that includes the data. For example, the object may be a page, a form, a field of a form, a user interface control, etc. An access mode (156A) specifies how the data is to be accessed by a script of the corresponding script type (154A). For example, the access mode (156A) may be “block” or “allow.” Continuing this example, the access mode may be “block” when the asset class, such as “password” or “email address,” has a high value. Alternatively, the access mode may be “allow” when the asset class, such as “company name” or “timestamp,” has a low value. A script type (154A) of a script may indicate a relationship between the script and the client applications (116). For example, the script type (154A) may indicate whether the script is a “first-party” script, a “third-party” script, an “Nth-party” script, a “first-party” tracker, etc. The remediation configuration (150) may be correspond to a user. For example, different remediation configurations may correspond to different users.

The machine learning model (160) includes functionality to classify data as an asset class (152). For example, the machine learning model (160) may, for specific data, generate scores corresponding to different candidate asset classes. Continuing this example, the machine learning model (160) may classify the specific data as the asset class corresponding to the highest score.

The server (122) is a computing device in accordance with the computing system (1200) and the nodes (1222) and (1224) described below in FIG. 12A and FIG. 12B. The server (122) includes the memory (130) (e.g., non-persistent storage (1204) and/or persistent storage (1206) of FIG. 12A) and the processor (126) (e.g., processor(s) (1202) of FIG. 12A) that store and execute applications that provide services to the client applications of the client devices (104). In one or more embodiments, the server (122) is multiple servers that respond to requests from the client devices (104).

The processor (126) executes the programs in the memory (130). In one or more embodiments, the processor (126) is multiple processors that execute programs and communicate with the client devices (104).

The memory (130) stores data and programs that are used and executed by the processor (126). The memory (130) includes one or more programs, such as the server application (134). The programs may be stored and executed on different memories, processors, and servers of the system (100).

In one or more embodiments, the server application (134) includes a server web browser (136) and an analysis engine (138). In one or more embodiments, the server application (134) is a program that responds to the requests from client applications of the client devices (104) using data from other programs, including the server web browser (136) and the analysis engine (138).

In one or more embodiments, the server web browser (136) simulates a user's interaction with an application (e.g., client applications (116) or a web service (182) hosted by the server (122)). The server web browser (136) may operate in a virtual machine hosted by the server (122). The server web browser (136) may be hosted by the server (122), but may be a third-party web browser that is executed as directed by the analysis engine (138) of the server application (134).

In one or more embodiments, the analysis engine (138) is a program that analyzes the operation of the server web browser (136). The analysis engine (138) may analyze data usage within the server web browser (136) and may analyze data sent from and received by the server web browser (136).

The analysis engine (138) includes functionality to generate the remediation configuration (150). For example, the analysis engine (138) may generate the remediation configuration (150) using rules that assign, for different asset classes (152), access modes (156A, 156K) corresponding to script types (154A, 154K). Alternatively, a user may define the remediation configuration (150) (e.g., using the graphical user interfaces (117) of the client application (116)).

Attention is returned to the repository (118) to define additional types of information stored on the repository (118). The repository (118) stores one or data (162). The data (162) is one or more data structures that contain computer-readable data which reflects sensitive information. Sensitive information is information that one or more users, or the operators of the server (122) seek to protect. Examples of sensitive information include, but are not limited to social security numbers, drivers licenses, banking account numbers, credit card numbers, routing numbers, demographic information, medical information, etc.

The data (162) may be transmitted to, or from, either the client devices (104) or the server (122). In the one or more embodiments, the data (162) may be the target of one or more client-side cyberattacks by malicious users.

The repository (118) also stores one or more requests (164). The requests (164) are computer-generated requests to access or to transmit the data (162) between a web service (182), defined below, and the client applications (116). The requests (164) may be received from the client applications (116), and in particular may be received from the client web browsers (115) executing in one or more runtime environments (188), defined below. The requests (164) may also be received from the web service (182).

The repository (118) also stores one or more security configurations (166) applicable to browser sessions (184) (defined below) generated for client web browsers (115) (also defined below). A security configuration is a configuration of security settings of a client device. In the repository, a security configuration is software instructions, rules, policies, or settings that define security settings to be applied to the client web browsers (115) and/or to the browser sessions (184) generated for the client web browsers (115).

The security configurations (166) include a selected access mode (168) applicable to scripts (190) (defined below) executable by the client web browsers (115) in the runtime environments (188). The term “access mode” refers to a permission state for a script, function, or program, or alternatively to the permission state for accessing a form or data. The selected access mode (168) may be selected from one of the access modes (e.g., access mode A (156A) through access mode K (156K)) in the remediation configuration (150) described above. The selected access mode (168) may be, for example, to block one or more of the scripts (190) prior to execution of the scripts (190), or to allow one or more of the scripts (190) prior to execution of the scripts (190).

The repository (118) may also store one or more web pages (170). The web pages (170) are data structures storing code, such as for example HTML code, which when executed or otherwise rendered displays text, images, sounds, etc. in a web browser, such as one of the client web browsers (115) or the server web browser (136). The web pages (170) may be stored locally with respect to the server (122), or may be stored remotely by a third party and then accessed by the server (122).

The repository (118) may also store modified native code (172). Native code, generally, is computer program code particular to one of the client applications (116) or the client web browsers (115). Native code may be executed in the runtime environments (188). For example, the native code may be written in JAVASCRIPT®, HyperText Markup Language (HTML), Cascading Style Sheets (CSS), etc. Thus, the modified native code (172) is native code that has been modified.

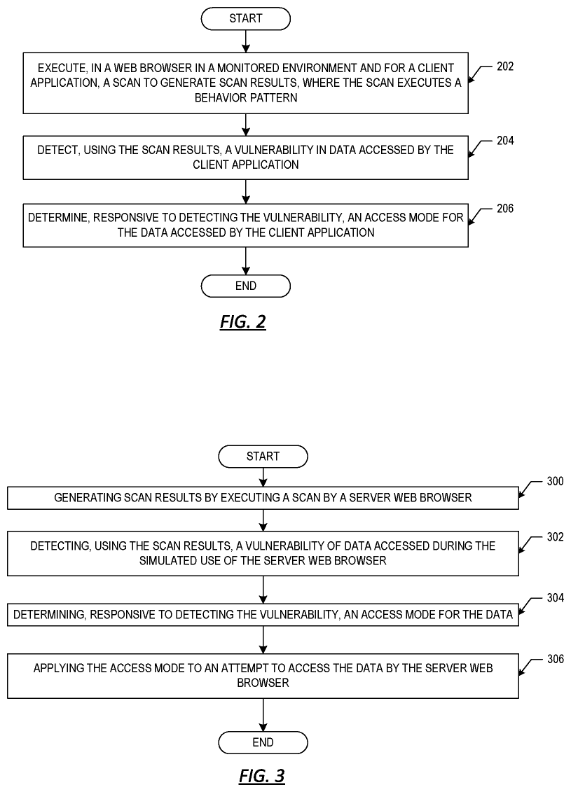

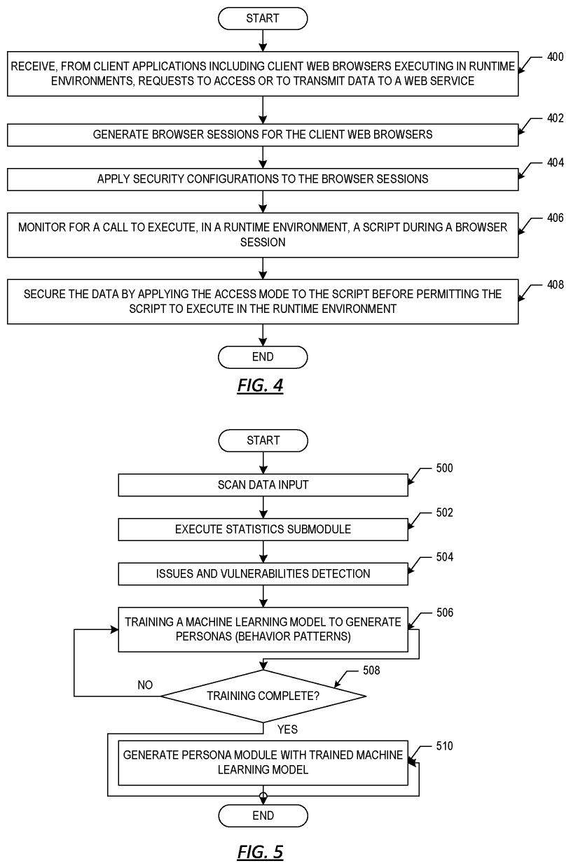

In particular, the modified native code (172) is a modification to the native code of one of the client applications (116) or the client web browsers (115). Still more particularly, a script analysis controller (186) (defined below) may substitute the native code of the client applications (116) or the client web browsers (115) with the modified native code (172). The purpose of the modified native code (172) is described with respect to FIG. 2 and FIG. 4.

The repository (118) also may store a browser-level security event (174). An event is an action or occurrence recognized by software. A browser-level security event is an action or occurrence in the web browser that exposes the data to (162) read, write, or deletion modification, possibly by a malicious entity. Thus, the browser-level security event (174) is an indication that the data (162) may be vulnerable for a reason determined in accordance with information received by the server application (134) during monitoring of the client applications (116) and client web browsers (115). For example, the browser-level security event (174) may be a call to execute one of the scripts (190). The browser-level security event (174) also may be a detection of malware on any of the client devices (104) or the server (122). The browser-level security event (174) also may be some indication that the data (162) has been accessed without proper authorizations. The browser-level security event (174) may take many different forms. Note that in some cases the browser-level security event (174) may be detected by the server (122) and not stored in the repository (118), or stored at some later time.

The repository (118) also stores a behavior pattern (176) among possibly many different behavior patterns. The behavior pattern (176) is a set of rules, policies, and possibly computer readable code that define how the server application (134) will interact with the server web browser (136) and/or the client applications (116) in order to emulate the use of a web browser by a human. Another term for a behavior pattern is a custom scenario, or a macro.

The behavior pattern (176) may direct the server web browser (136) to interact with the web service (182). Thus, the behavior pattern (176) does not directly engage the web service (182), but rather use the server web browser (136) just as a human user would use the server web browser (136). Thus, for example, the behavior pattern (176) may direct a series of mouse clicks on widgets of one or more of the web pages (170), fill in forms, attempt to purchase goods, conduct transactions, etc.

The behavior pattern may specify scheduling of how a server web browser is used. The schedule may include parameters such as star time, end time, pauses during a session, random initiation and termination of browser sessions, specific dates of use, etc. Additionally, the behavior pattern may specify the scope of use of the server web browser, such as for example to attempt to access one or more different aspects of a web service or a website.

The behavior pattern (176) may include clicking on a page element, including clicking buttons, clicking multiple times, simulated random mouse movements, delays between clicks, etc. The behavior pattern (176) may include focusing on page elements, hovering a mouse cursor over a page element, tapping on page elements, typing custom text in a page element that can receive content, selecting an option from a dropdown menu, waiting for a time, waiting for a custom page element to appear on a web page, engaging with native browser dialog handlers (clear, dismiss, etc.), perform keyboard actions (press or release any key on the keyboard, etc.), and possibly many other actions.

Thus, the behavior pattern (176) may be characterized as having a “persona.” The persona is defined by a set of attributes and characteristics that represent the behavior of a human user to better imitate a real user during a scan, as described with respect to FIG. 2. The persona is characterized by set of attributes and parameters which include but not limited to geolocation of the source of monitoring, type of internet service provider (mobile, home, business, data center, etc.), visitor's device type (which may include but not limited to a mobile phone, desktop, laptop, tablet, smartwatch, etc.) age, gender, browsing history, interests, background information, racial or ethnic origin; political opinions, religious or philosophical beliefs; trade-union membership; genetic data, biometric data processed solely to identify a human being; health-related data; data concerning a person's sex life or sexual orientation.

The behavior pattern (176) of the persona is characterized by parameters which include, but are not limited to, opening a specified list of pages, visiting pages in a predefined order, or visiting pages in an order chosen by the system. Other parameters include performing activities on pages which may include, but are not limited to, scrolling through the page, interacting with some or all elements of the page, entering random keystrokes, entering predefined text or keystrokes, text or keystrokes chosen by the system in fields and forms and other parts of the page, or text or keystrokes provided by a web browser or application form auto-fill functionality. The parameters may include functionalities that enable a set of predefined text or keystrokes to be selected and entered into fields and forms, or other parts of the page, performing transaction activities. The transaction activities may include, but are not limited to, performing a purchase transaction. The purchase transaction may include, but is not limited to, reviewing product selections, making a selection, adding a product into a purchase cart, providing billing, shipping and other information. The other information may include, but is not limited to, credit card information, PayPal account information, debit billing information, etc. The transaction activities also may include performing user account update activities which may include, but are not limited to, updating or changing user names, changing user contact information (email, phone, etc.), password, gender, address, etc.

The behavior pattern (176) is applied by the analysis engine (138) of the server application (134) in order to perform a scan. A scan is an interaction of the behavior pattern (176) with the web service (182) via execution of the server web browser (136) using the behavior pattern (176). A scan is used as part of checking the web service (182) for vulnerabilities.

Each scan may have a set of parameters that configure the scan. A configured scan may be referred-to as a project. A project may combine parameters for web, mobile, and other platforms that are suitable for performing intelligent analytics. Scans may support authentication, meaning if the resource that needs to be scanned is behind a password, a firewall, or any sort of gate, the behavior pattern (176) can be configured to bypass the authentication. Use of the scan is described with respect to FIG. 2 and FIG. 3.

The repository (118) may also store scan results (178). The scan results (178) may be the information generated by executing a scan using the analysis engine (138) of the server application (134). The scan results (178) may include statistics reporting, vulnerability detection, and training parameters generated by training a machine learning model based on the other results of the scan. The scan results (178) may include the results of validations and checks, records of data transfers from form fields, analysis of network traffic to determine who sends or receives data, scripts executed, etc. The scan results (178) also may include reports. The scan results may be provided to the machine learning model (160).

The reports may include a geographical report. The geographical report may include a list of data transfers to geographical destinations (Country, city, metro). The geographical report may include an amount of requests made to each destination, request and response samples, an identity of an initiator, a chain of the scripts involved in a data transfer, a timeline of the requests, a date, a time, an internet protocol address, etc., used to determine the geographical location.

The reports may include a tracker report. The tracker report may include detected third-party trackers and the entity or company associated with a tracker. Trackers are detected based on a number of factors including, but not limited to, internet protocol address, uniform resource link, script name, etc.

The reports may include a forms report. The forms report includes detected forms and input fields, the number of fields, field types, and other form parameters.

The reports may include a scripts report. The scripts report may include script tags detected, including inline, first-party, third-party and Nth party scripts, alongside number of detections and page drilldowns. Additionally, the scripts report may include a scripts delta report, which provides a visual representation showing which scripts change from scan to scan, and particularly showing what has changed, in order to compare different scans.

The reports may include a list of data recipients, including but not limited to countries, companies, internet protocol addresses, uniform resource link, and other types of recipients. The reports may include lists of scanned objects, including but not limited to websites, pages, parts of webpages, frames, etc. The reports may include lists of detected technologies, including but not limited to tools, behavior trackers, ad trackers, beacons, scripts, code, social media tools, scripts, tags, etc. The reports may include lists of detected activities performed by technologies, including but not limited to: collecting visitor data; sending various types of data, such as visitor data to an external recipient or recipients; performing processing of data or information, such as analyzing data or information, encoding data or information, encrypting data or information, performing machine learning activities on data or information, performing other types of processing activities; deletion of data or information; and storing data or information on mediums such as a visitor's device, a visitor's browser, servers, cookie files, other types of files or locations. The reports may also include lists of technologies, such as tools, scripts, code, behavior trackers, ad trackers, beacons, social media tools, scripts, tags, etc., that are present on pages with information presented to user/visitor. The reports may also include forms, frames and other types of page elements that provide the ability for a user to enter information or data into a page or an application or provide an output of data or information to a user or to a system in human readable or machine readable format.

The reports may include one or more lists of data recipients, including but not limited to countries, companies, IP addresses, and URL and other types of recipients. The reports may include one or more lists of scanned objects, including but not limited websites, pages, parts of webpages, frames, etc. The reports may include one or more lists of detected technologies, including but not limited to tools, behavior trackers, ad trackers, beacons, scripts, code, social media tools, scripts, tags, etc.

The reports may include lists of detected activities. Lists of detected activities performed by technologies include, but are not limited to: Collecting visitor data, sending various types of data (including but not limited to visitor data to an external recipient or recipients), performing processing of data or information (including but not limited to analyzing data or information, encoding data or information, encrypting data or information, performing machine learning activities on data or information, performing other types of processing activities), deletion of data or information, storing of data or information on mediums (including but not limited to visitor's device, visitor's browser, servers, cookie files, other types of files or locations).

The reports may include one or more lists of technologies. The lists of technologies may include, but are not limited to tools, scripts, code, behavior trackers, ad trackers, beacons, social media tools, scripts, tags, etc. Such technologies may be present on pages with information presented to user.

The reports may include a presentation of forms, frames, and other types of page elements that provide the user with the ability to enter information or data into a page or application. The presentation of forms and frames may also describe such data when output to an external source, and specify whether the output is in human-readable or machine-readable format.

The scan results may include many other types of information. For example, the scan results may include a vulnerability report. A vulnerability report may indicate detection of a chain loading attack, skimming attack, or keystroke or form autofill snooping. The vulnerability report may indicate compliance, or lack thereof, with respect to security policies, regulations, frameworks, rules, guidelines, etc., such as GDPR, CSP, PCI-DSS, CCPA, PIPEDA, NIST, etc. The vulnerability report may indicate what kind of data is being sent out from or received by web pages.

The repository (118) may communicate with other elements of the system (100) via a network (180). The network (180) may be the network shown in FIG. 12B. The network may be a local area network, wide area network, the Internet, or some other network communicating via wired or wireless communications.

The system (100) shown in FIG. 1 also includes other elements, such as the web service (182) executable by the server (122). The web service (182) is one or more programs and/or one or more of the web pages (170) that provide an online service to any of the client web browsers (115) or the server web browser (136). For example, the web service (182) may be an online shopping cite that displays products and provides an online marketplace to purchase the products. The web service (182) may be an Internet search engine. The web service (182) may be a collection of web pages (170) that forms a “web site” for a company.

While the web service (182) is shown as executable by the server (122), the web service (182) may also be a third-party service hosted by a third party server. In this case, the web service (182) remains in communication with the server (122), the server web browser (136), and/or the client web browsers (115).

The system (100) shown in FIG. 1 also includes one or more browser sessions (184). A browser session, in the one or more embodiments, is a record of a series of continuous actions by a visitor on a website within a given time frame. For example, the web service (182) may generate, store, and use a session identifier to respond to user interactions during a web session. The session identifier is part of the browser session. The browser sessions (184) may be used to avoid storing unwanted data in the server web browser (136) or the client web browsers (115). Each time a user takes an action or makes a request on the web service (182), the browser sends the session identifier and possibly a cookie identifier to the server (122), along with a description of the action. The description also becomes part of the session. Once the web service (182) accrues sufficient information on how a user traverses a web site, the website may be customized for the browser session.

The system (100) shown in FIG. 1 also includes a script analysis controller (186) executable on the server (122). The script analysis controller (186) is a program executed by the server application (134) or by the server independently of the server application (134). The script analysis controller (186) may be injected into websites as part of generating the one or more browser sessions (184). The script analysis controller (186) may monitor for the execution of scripts (190) on the client devices (104), and take security actions in response. For example, the script analysis controller (186) may apply the selected access mode (168) to one or more of the scripts (190) prior to execution of the one or more scripts (190). Further details on the operation of the script analysis controller (186) are described with respect to FIG. 4.

The scripts (190), in turn, are computer programs that execute in the runtime environments (188) on the client devices (104). A runtime environment is the hardware and software infrastructure that supports the execution of a particular program, such as the scripts (190), the client web browsers (115), the client applications (116), and the native code (192).

The scripts (190) may be part of the client web browsers (115) or called by the client web browsers (115). The scripts (190) may perform many different functions, such as to display information on the graphical user interfaces (117), display a form, present a widget, take actions in response to activation of a widget, etc. A widget is a button, drop-down menu, or some other device presented on a GUI with which a user may interact. In some cases, one or more of the scripts (190) may be planted by a malicious user in order to perform a client-side attack.

The scripts (190) may be written in or take the form of native code (192). The native code (192) may be written in JAVASCRIPT®, Python, C++, or many other programming languages. The client applications (116) may likewise be written in the native code (192).

While FIG. 1 shows a configuration of components, other configurations may be used without departing from the scope of the one or more embodiments. For example, various components may be combined to create a single component. As another example, the functionality performed by a single component may be performed by two or more components. The various elements, systems, and components shown in FIG. 1 may be omitted, repeated, combined, and/or altered. Accordingly, the scope of the present disclosure should not be considered limited to the specific arrangements shown in FIG. 1.

FIG. 2 shows a flowchart of a process in accordance with one or more embodiments of the disclosure for remediating security risks. The method of FIG. 2 may be implemented using the system shown in FIG. 1.

In Step 202, scan results are generated by executing a scan in a web browser in a monitored environment for a client application, such as the runtime environment described with respect to FIG. 1. The monitored environment may be a runtime execution environment for the web browser. The scan executes one or more behavior patterns. The scan results may include a log of attempts to access data by one or more scripts and/or trackers. In one or more embodiments, the one or more behavior patterns are executed by a program that is external to the web browser.

In Step 204, a vulnerability in data accessed by the client application is detected using the scan results. The vulnerability may be due to a script accessing the data. The analysis engine may determine that the client application calls native code of the monitored environment to access the data. For example, the native code may be written in JAVASCRIPT®, HyperText Markup Language (HTML), Cascading Style Sheets (CSS), etc.

The analysis engine may detect malware and/or unauthorized code in data accessed by the client application using the scan results. Malware is any software intentionally (e.g., maliciously) designed to cause damage to a computer, server, client, or computer network. A wide variety of malware types exist, including computer viruses, worms, Trojan horses, ransomware, spyware, adware, rogue software, etc.

The analysis engine may generate a threat model corresponding to the malware and/or unauthorized code. The threat model may include a data flow corresponding to data used by the malware and/or unauthorized code. The data flow may be represented in one or more data flow diagrams. The threat model may include an attack surface map corresponding to one or more portions of the client application targeted by the malware and/or unauthorized code. The analysis engine may present the threat model, data flow and/or attack surface map in a graphical user interface (GUI).

In Step 206, an access mode for the data accessed by the client application is determined responsive to detecting the vulnerability. The analysis engine may obtain the access mode from a remediation configuration for an asset class of the data accessed by the client application and a script type of a script attempting to access the data. The remediation configuration may be determined by the machine learning model. Alternatively, the remediation configuration may be specified by a user.

The analysis engine may replace the native code with modified native code including functionality to (i) observe an attempt to access the data, and (ii) comply with the access mode when an attempt to access the data is executed. For example, when the remediation configuration indicates an access mode of “block” for the asset class and the script type, the modified native code may block an attempt to access the data by a script corresponding to the script type.

In one or more embodiments, an alert is generated responsive to detecting the vulnerability. The alert may identify the native code called by the client application that caused the vulnerability. For example, the alert may recommend upgrading or removing a framework used by the client application.

In view of FIG. 1 and FIG. 2, the one or more embodiments provide for an exemplary method. The exemplary method includes executing, in a web browser in a monitored environment and for a client application, a scan to generate scan results, wherein the scan executes a behavior pattern. The method also includes detecting, using the scan results, a vulnerability in data accessed by the client application. The method also includes determining, responsive to detecting the vulnerability, an access mode for the data accessed by the client application. In one embodiment, the method may terminate thereafter.

The method described above may be varied. The method may also include determining that the client application accesses the data using native code of the monitored environment. The method may also include replacing the native code with modified native code including functionality to (i) observe an attempt to access the data, and (ii) comply with the access mode when an attempt to access the data is executed.

In another embodiment, the method may also include determining, using a machine learning model, an asset class of the data. The access mode is determined using the asset class. In yet another embodiment, the method may also include detecting, using the scan results, malware in data accessed by the client application. In still another embodiment, the method may also include generating a threat model and presenting the threat model in a graphical user interface (GUI). Still other variations are possible.

FIG. 3 is a flowchart of a method for improving the cyber security of a web service, in accordance with one or more embodiments. The method of FIG. 3 may be implemented using the system of FIG. 1. The method of FIG. 3 may be characterized as a method of analyzing and remediating a web service.

Step 300 includes generating scan results by executing a scan by a server web browser. The scan may be executed by the analysis engine (138) of the server application (134) described with respect to FIG. 1. The scan is a behavior pattern that defines a simulated use of the server web browser to access a web service. Executing the scan includes causing a server web browser to access the web service according to the behavior pattern. The scan results include monitoring information generated by monitoring execution of the scan.

In another embodiment, the scan may be performed using one or more client web browsers (115). For example, the server application (134) may request that a user of the client web browsers (115) grant permission to perform the scan as part of increasing the security of the web service (182).

Step 302 includes detecting, using the scan results, a vulnerability of data accessed during the simulated use of the server web browser. The vulnerability may be detected using a machine learning model. For example, the scan results may be turned into a vector, which a data structure suitable for inputting data to the machine learning model. The machine learning model may then classify the scan results to indicate the presence and/or type of the vulnerability.

In a specific example, detecting the vulnerability may include determining, using the machine learning model, an asset class of the data. Then, rules may be used to determine the access mode using the asset class and a script type of a script attempting to access the data. The rules may be selected from a remediation configuration.

When detecting the vulnerability, the vulnerable data may be provided by the server web browser to the web service. The vulnerable data also may be provided by the web service to the server web browser, or a combination of receipt and transmission of the vulnerable data.

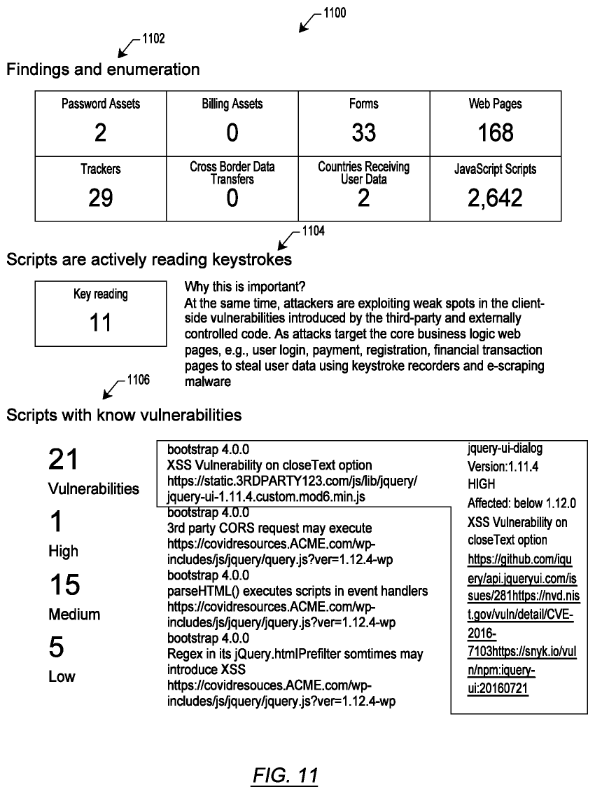

A further example of detecting a vulnerability using the scan results is described with respect to FIG. 11. Thus, the one or more embodiments are not limited to the above examples.

Step 304 includes determining, responsive to detecting the vulnerability, an access mode for the data. Determining the access mode may be performed by selecting an access mode from a remediation configuration, as described with respect to FIG. 2. For example, if the vulnerability is a script, then the access mode for the script type of the script may be applied to the script. Thus, the access mode may be specific to a script type of a script attempting to access the data, and the access mode blocks execution of the script. In another example, if the vulnerability is a form field, then the access mode may be determined to be instructions to prevent the form field from being used until the form field can be secured.

Step 306 includes applying the access mode to an attempt to access the data by the server web browser. The access mode may be applied by determining that the server web browser accesses the data using native code of the monitored environment. Then, the native code is replaced with modified native code including functionality to (i) observe an attempt to access the data, and (ii) comply with the access mode when an attempt to access the data is executed.

The access mode also may be applied by monitoring for execution of a script on the web browser. When the script is called, the access mode may be used to block execution of the script.

The access mode also may be applied by preventing transmission of a web page, or a portion of a web page. The access mode may also be applied by terminating a browser session. The access mode may be applied using still other techniques. In one embodiment, the method of FIG. 1 may terminate thereafter.

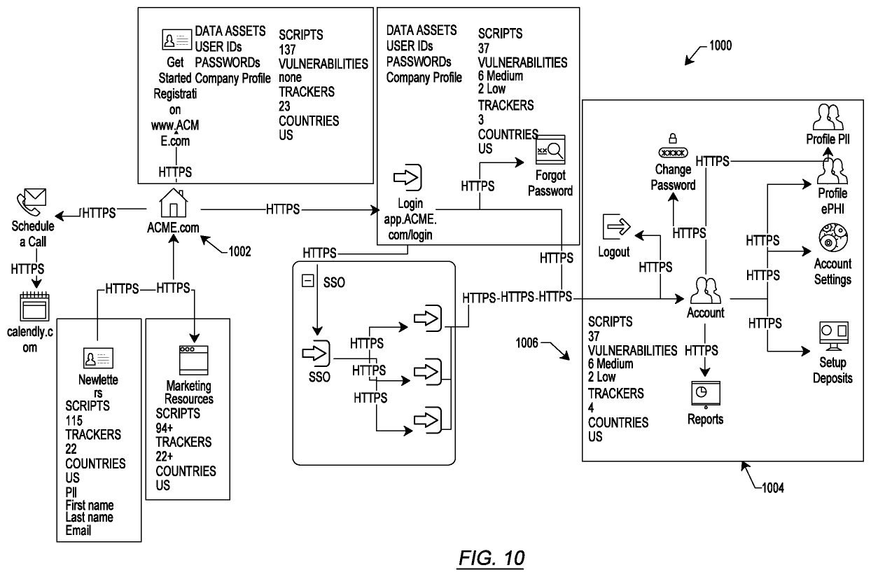

The method of FIG. 3 may be further extended or may be modified. For example, the method of FIG. 3 may also include detecting, using the scan results, malware in the data accessed by the server web browser. Then, in response to detecting the malware, a threat model may be generated. The threat model may be presented in a GUI. The threat model may include a data flow corresponding to data used by the malware. The threat model may take the form of an attack surface map corresponding to one or more portions of the server web browser targeted by the malware. An example of a threat model, including an attack surface map, is presented with respect to FIG. 10.

In yet another variation of the method of FIG. 3, the method may also include automatically remediating the server web browser, and/or the web service. Remediation may take the form of presenting a list of mitigation recommendations against unauthorized data access. Remediation also may take the form of presenting a change log describing a change in the server web browser. Remediation also may take the form of setting a content security policy or initiating tag control. Remediation also may take the form of applying a compliance requirement to the server web browser, or enabling disabling, pausing, or configuring a security setting. Other variations are possible.

Attention is now turned to FIG. 4. The method of FIG. 4 may be characterized as a method of monitoring client web browsers during browser sessions. The method of FIG. 4 may be implemented using the system shown in FIG. 1. The method of FIG. 4 may be performed in addition to the method shown in FIG. 3.

At step 400 the method includes receiving, from client applications including client web browsers executing in runtime environments, requests to access or to transmit data to a web service. The requests to access or transmit the data may be received over a network. For example, a web browser may communicate a request to retrieve financial data from a bank web service. The web browser may also access the web service in order to submit information to the web service, such as to transmit data entered into a form shown in a GUI of the web browser.

At step 402, the method includes generating browser sessions for the client web browsers. The browser sessions may be established at a server by issuing an identifier to a web browser that has established communication with the web server. Electronic communications between the web browsers and the web service are stored as part of a record that forms the contents of the browser sessions.

Generation of the browser sessions may be performed responsive to receiving at step 400. However, the browser sessions may have been previously established at some prior point to communicating any information or requests for information

Step 404 includes applying security configurations to the browser sessions. The security configurations include an access mode applicable to a scripts executable by the client web browsers in the runtime environments. Applying the security configurations may be performed using a script analysis controller in communication with the web service. Applying the security configurations may include assigning the script analysis controller to monitor a web session, and/or to inject replacement native code into a client web browser. Applying the security configurations may also include transmitting one or more cookies to the client web browser with instructions to apply security settings, such as to require a password to enter data into a form.

Many other security configurations may be applied. For example, the script analysis controller may be automatically instrumented on web pages generated by the web service. In this case, the script analysis controller applies the security configurations to the browser sessions via programming from the script analysis controller that is added to the web pages.

Step 406 includes monitoring for a call to execute, in a runtime environment of the runtime environments, a script during a browser session. Monitoring may be performed by the script analysis controller during the browser sessions. Monitoring may be performed by the script analysis controller monitoring for a call by the client web browser or the client application to execute a script. When the call to execute the script is issued, then the script analysis controller is configured to interrupt execution of the script, as described below.

Step 408 includes securing the data by applying the access mode to the script before permitting the script to execute in the runtime environment. The access mode may be applied by interrupting the execution immediately after the call and then programming the client web browser to either allow or block execution of the script. In an embodiment, the script analysis controller may replace the native code with modified native code including functionality to (i) observe an attempt to access the data, and (ii) comply with the access mode when an attempt to access the data is executed. For example, when the remediation configuration indicates an access mode of “block” for an asset class and a script type, the modified native code may block an attempt to access the data by a script corresponding to the script type.

Attention is now turned to FIG. 5. The method of FIG. 5 may be characterized as a method of executing an analysis flow to generate a behavior pattern (176) using the server application (134) of FIG. 1, and/or one or more of the client applications (116) of the client devices (104), presented in FIG. 1. The method of FIG. 5 may be implemented using the system shown in FIG. 1.

Step 500 includes scanning data input. Scanning may be performed by executing a behavior pattern using one or more server web browsers or one or more client web browsers, as further described above.

Step 502 includes executing a statistics submodule. The statistics submodule may be software and/or application-specific hardware programmed to generate statistics using the information gathered at step 500. For example, a check may be performed whether a particular combination of information is present after the scan. If the combination is present, then a new statistic is generated to indicate that the combination is present and thus represents an increased or decreased chance that a malicious cyber attack is taking place or that malware is present in one or more of the client web browsers, the server web browsers, or some aspect of the web service (such as one or more of the web pages).

Step 504 includes detecting issues and vulnerabilities. The issues and vulnerabilities may be performed by executing a scan, as described above, using previously generated personas or by asking a user to access a web service using a web browser. The issues and vulnerabilities may be presented in a threat model (FIG. 10) or a surface report (FIG. 11).

Step 506 includes training a machine learning model (i.e. an artificial intelligence model) to generate one or more personas (e.g., behavior patterns). Training may be performed by inputting data having a known result to the machine learning model. The model then executes on the input data and outputs an intermediate result, which represents an intermediate prediction or an intermediate classification regarding the input data. The intermediate result is then compared to the known result. If the known result and the intermediate result differ by more than a predetermined amount, then training is deemed incomplete.

As a result, a loss function is generated. The loss function is a program or formula that guesses at how to adjust the parameters of the machine learning model in order for a subsequent execution of the machine learning model to be closer to the known result. Changing the parameters changes the output of the machine learning model. The parameters of the machine learning model are then adjusted according to the loss function.

Thereafter, the modified machine learning model is executed again using the known data as input. The process of comparing the known result to the intermediate result repeats until convergence occurs. Convergence is defined as the known result being within a predetermined mathematical closeness to the intermediate result, or after a predetermined number of times that the cycle of training has been repeated.

Thus, if training is not complete (i.e., convergence is not achieved) at step 508, then the process of training returns to step 506 and continues. Otherwise, if training is complete (i.e., convergence is achieved) at step 508, then the process continues. Once convergence is achieved the machine learning model is deemed to be a trained machine learning model, and then may be applied to unknown data in order to make predictions regarding the unknown data, or to classify the unknown data. In the one or more embodiments, the machine learning model is trained to classify combinations of the scan data input, the statistics, and issues and vulnerabilities as different personas.

Step 510 includes generating a persona module with the trained machine learning model trained at steps 506 and 508. The persona module is generated by generating one or more personas, and storing the personas as part of behavior patterns to be used in future scans. Multiple personas may be generated by applying the scan data input, the statistics, and the issues and vulnerabilities detected at steps 500, 502, and 504 to the trained machine learning model. The trained machine learning model outputs classifications of combinations of the input data as one or more personas. The personas are stored in the persona module for future use as behavior patterns when scanning a web service or monitoring client web browsers or client web applications.

Attention is now turned to FIG. 6. The method of FIG. 6 may be characterized as a method of remediating a webs service and/or monitoring one or more client web applications. The method of FIG. 6 may be implemented using the system shown in FIG. 1.

At step 600, the method includes determining whether the script analysis controller will operate in automatic mode. If not, then at step 602 a user configures rules to be applied by the script analysis controller. If so, then the script analysis controller will automatically determine the rules to be applied during monitoring.

After step 600 or step 602, step 604 includes installing the script analysis controller. The script analysis controller may be installed in each web page of a website provided by a web service. For example, code that forms part or all of the script analysis controller may be called when a client web browser attempts to access information from a web page.

Step 606 includes performing runtime. Performing runtime includes permitting client web browsers to access one or more web pages or other aspects of the web service. As indicated above, each time a client web browser accesses a web page, the script analysis controller may be engaged. The script analysis controller may inject modified native code into the client web browser in order to cause the client web browser to allow and apply the access mode determined for a particular script called by the client web browser, as explained above.

Additionally analyses may take place concurrently during runtime at step 606. For example, at step 608 an analysis of data being transferred may be performed. If an anomalous transfer of data occurs (e.g., data is transmitted to an unexpected internet protocol address), then the access mode may be engaged to block further data transfer. Data transfer analysis may be ongoing, and thus continue until a determination is made to end the data transfer analysis at step 610.

In another example, at step 612 a user behavior analysis may be performed. For example, certain patterns of user behavior while using a web browser may indicate a higher or lower probability that the user behavior corresponds to malicious use. In a more particular example, a repeated pattern of clicks on a particular set of widgets may indicate that malware is attempting to gain access to the web service. User behavior analysis may be ongoing, and thus continue until a determination is made to end the user behavior analysis at step 614.

Attention is now turned to FIG. 7. The method of FIG. 7 may be characterized as a method of simulating a user via execution of a behavior pattern. The method of FIG. 7 may be implemented using the system shown in FIG. 1.

Step 700 includes initiating a scan. The scan may be initiated by a script analysis controller by instructing the analysis controller to scan a web service and/or one or more web pages of the web service.

Step 702 includes determining whether the scan should be performed behind a password (i.e., whether authentication is needed in order to access certain aspects of the web service and/or web pages). If yes, then step 704 includes performing an authentication configuration for the scan. The authentication configuration may include, for example, providing the analysis engine with the password(s) and/or other forms of authentication to be passed during the scan. The authentication configuration may also include some other means for bypassing the authentication. After authentication configuration at step 704, or if the scan is not performed behind a password at step 702, then the method continues to step 704.

Step 704 includes determining whether a specific user persona profiles will be used. If so, then step 706 includes loading the particular user persona profile for the scan. If not, then step 708 includes loading a default persona profile for the scan. Loading a personal profile may be performed by instructing the analysis engine to call the specified persona during a scan.

After either step 706 or step 708, then step 710 includes starting the scan. The scan is initiated by the analysis engine issuing an instruction to a server web browser to begin traversing the web service and/or one or more web pages according to the loaded persona profile. Step 712 then includes loading a simulation device. Loading the simulation device may include loading the server web browser and initiating a browser session using the sever web browser.

Step 714 includes loading person environment options to be used during operation of the server web browser as the simulated person (the persona profile) uses the server web browser. Thereafter, or concurrently, step 716 includes loading the simulator (the persona profile) history and/or data. After step 714, or concurrently, step 718 includes connecting the server web browser to the desired Internet service provider in a selected country, city, and or region.

For each of step 714, 716, and 718 the loading of options and connection to the Internet service provider may be performed by the analysis engine referencing the persona profile. For example, the persona profile may specify the geolocation of the source of monitoring, the type of Internet service provider (mobile, home, business, data center, etc.), visitor's device type (which may include but not limited to a mobile phone, desktop, laptop, tablet, smartwatch, etc.) age, gender, browsing history, interests, background information, racial or ethnic origin, political opinions, religious or philosophical beliefs, trade-union membership, genetic data, biometric data processed solely to identify a human being, health-related data, data concerning a person's sex life or sexual orientation, and the like.

Step 720 includes loading the target application. The target application may be a program provided by the web service. The target application may be an interactive website. The target application may be a client application, in some cases, where the web service enables communication with client web browsers.

Steps 722 through 732 all relate to performing actions through the server web browser. The analysis engine uses the persona profile to determine which actions to take, how many times actions should be performed, and the order in which to perform the actions. Thus, steps 722 through 732 may be performed in an order other than that shown, certain steps may be skipped, and additional steps and actions may be present.

Step 722 includes engaging in visual interactions with the web site or web service. For example, a server web browser may be instructed to read text on a GUI via screen scraping.

Step 724 includes clicking and tapping. For example, a server web browser may be instructed to click or tap on pre-determined widgets displayed on the GUI.

Step 726 includes waiting and delaying. For example, a server web browser may be instructed to wait before selecting a widget, or to delay a random amount of time before moving a mouse cursor.

Step 728 includes executing a custom script and/or a macro. A macro is, like a script, a short computer program. For example, a server web browser may be instructed to execute a script or a macro to respond to a series of prompts generated by a website, or to submit some other type of input on a web page.

Step 730 includes inputting data (text, pictures, etc.) into a form. For example, a server web browser may be instructed to input a name, address, and phone number into the corresponding fields of a form presented by the web page.

Step 732 includes performing cursor movements. For example, a server web browser may be instructed to move a cursor in a random pattern prior to moving the cursor onto a selected widget or area of a GUI presented by a web page.

After performing step 722 through step 732, step 734 includes gathering data for analysis. The analysis engine may store the responses of the web page in response to the inputs provided in step 722 through step 732. The stored information may then be used for further analysis, such as to generate a threat model or a surface report, as shown in FIG. 10 and FIG. 11, respectively.

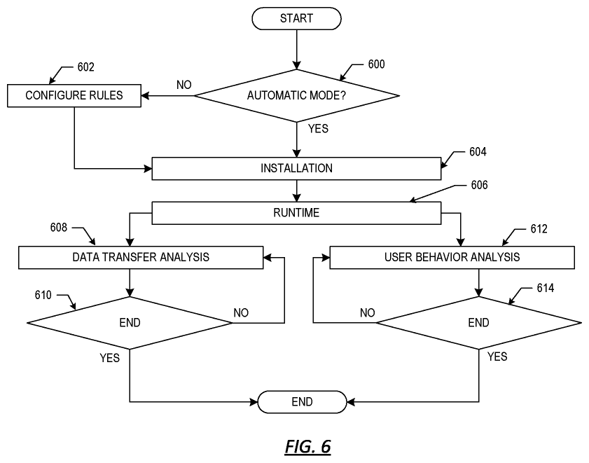

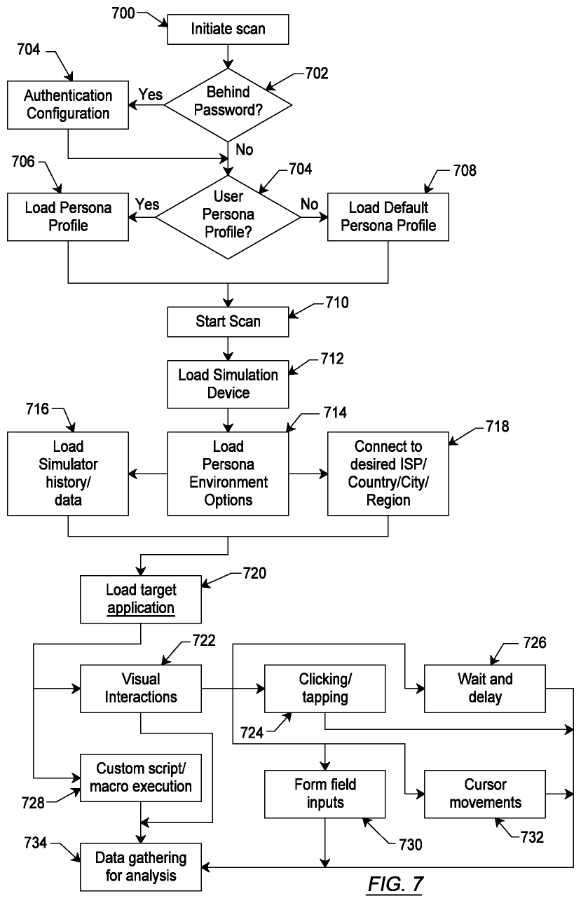

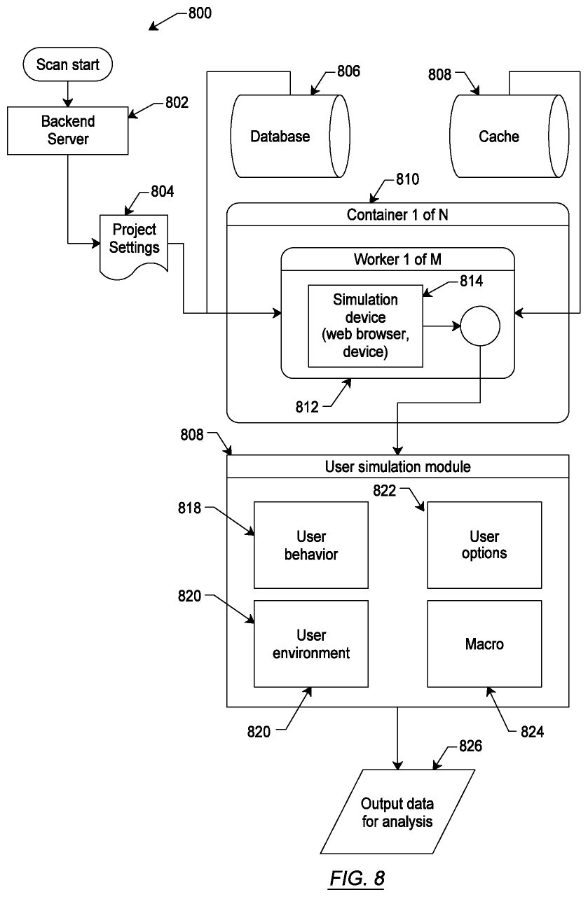

Attention is now turned to FIG. 8. FIG. 8 shows a user simulation system diagram. Thus, FIG. 8 shows a variation of the system of FIG. 1. The user simulation system diagram shown in FIG. 8 may be used to execute the simulation flow shown in FIG. 7.

System (800) includes a backend server (802), such as the server (122) of FIG. 1. The backend server (802) may have characteristics similar to those described for the server (122) described with respect to FIG. 1.

During a scan, the backend server (802) may load or reference project settings (804). Project settings are the settings defined for a project. A project may be to perform a scan of an existing web service and/or or one or more web pages of a website. The project settings may include one or more behavior platforms, persona profiles, security settings, the type of data to be gathered, whether monitoring, analysis, or both is to be performed, etc.

The project settings (804) may be stored in a database (806). The database (806) may be as described with respect to one or more of the repository (118), the memory (130), and/or the memories (112) described with respect to FIG. 1. The database (806) may store similar information.

The backend server (802) may draw upon a cache (808) during execution of a project. The cache (808) is a form of temporary memory that a processor may access more quickly than the information stored on the database (806). Thus, the cache (808) permits the backend server (802) to execute projects more quickly, relative to referencing only the database (806).

The backend server (802) generates a number of containers, such as container (810), which may be one of the containers between container 1 and container “N”. A container is a self-contained system of program code and data, many may include, for example, a virtual machine. Thus, for example, the container (810) may emulate not only a particular server web browser, but also behave as if the container were executing on a particular type of computer different than the backend server (802) (e.g., a client computer) and execute in a particular runtime environment, as if the server web browser were accessing the web service from a pre-designation location in the world.

The container may include a worker, such as worker (812). The worker (812) may be, for example, a virtual machine. The worker (812) may be used to execute a simulation device (814), such as a client web-browser, server web browser, client application, or some other program. In an embodiment, the simulation device (814) is a server web browser. In another embodiment, the simulation device (814) may be the script analysis controller (186) or the analysis engine (138) described with respect to FIG. 1. The simulation device (814) may emulate other computer programs or user devices.

The simulation device (814) may call or reference a user simulation module (816). The user simulation module may be used to select or otherwise provide a behavior pattern or persona to the simulation device (814). Thus, for example, the user simulation module (816) may describe user behavior in a behavior profile (e.g., behavior pattern or persona profile), a user environment (820) (e.g., specify the type of web browser to be used, the type of machine to be used, the simulated location of the user device, etc.), designate user options (822) (e.g., types of users, user goals when using a targeted web service or web site, etc.), and designate macros (824) to be executed when the simulation device (814) simulates use of the web service or web site.

The output data (826) of the simulation device (814) thereafter is stored, such as in the database (806). The output data may be used for later analysis, as described above.

While the various steps in the flowcharts of FIG. 2 through FIG. 8 are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments. By way of an example, determination steps may not require a processor to process an instruction unless an interrupt is received to signify that condition exists in accordance with one or more embodiments. As another example, determination steps may be performed by performing a test, such as checking a data value to test whether the value is consistent with the tested condition in accordance with one or more embodiments. Thus, the one or more embodiments are not necessarily limited by the examples provided herein.

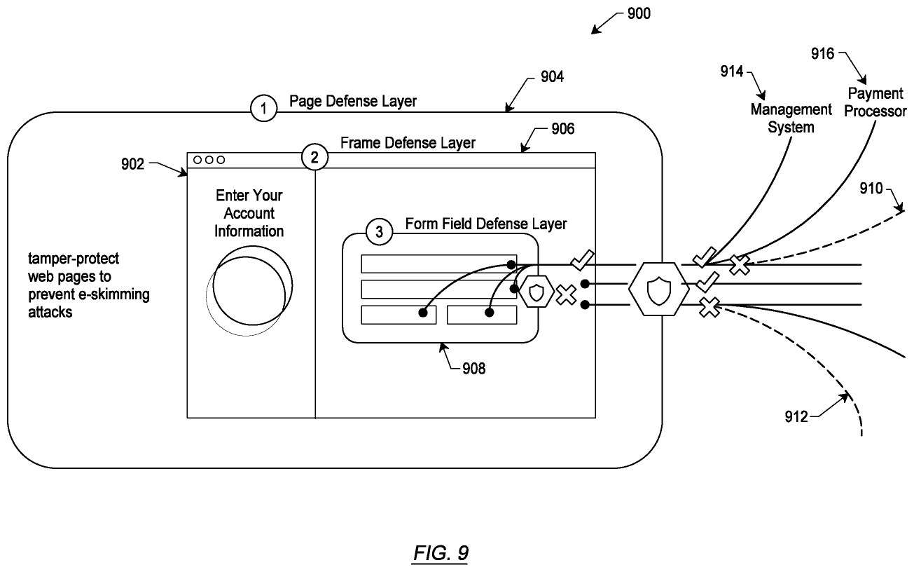

FIG. 9 through FIG. 11 present specific examples. The following examples are for explanatory purposes only and not intended to limit the scope of the one or more embodiments.

FIG. 9 shows an example of an application security controller (900) that provides client side protection against malicious attacks. The application security controller (900) may be, for example, the script analysis controller (186) shown in FIG. 1.

The application security controller (900) includes three layers of defense for a client-side application, such as a client web browser (902). The first layer of defense is a page defense layer (904), the second layer of defense is a frame defense layer (906), and the third layer of defense is a form field defense layer (908). All three layers may be integrated directly into the runtime environment of the client web browser (902), as described with respect to FIG. 1. Furthermore, the application security controller (900) may be auto-instrumented on every web page of a website in order to ensure that application security configurations are applied to every user browser session.

The page defense layer (904) defends against skimming attacks, such as a Magecart attack (as indicated by arrow (910)) and Pipka attack (as indicated by arrow (912)), as well as certain other data harvesting, form jacking, side loading, and chain loading attacks. The page defense layer (904) detects unauthorized script files, code behavior, and uses the procedures described with respect to FIG. 1 through FIG. 8 to block unauthorized behavior while the client web browser (902) is in use. However, whitelisted legitimate systems, such as a management system (914) or a payment processor (916) are allowed to execute scripts and behave normally with respect to the client web browser (902).

The frame defense layer (906) performs frame blocking. The frame defense layer (906) blocks unauthorized frames through the use of various tags, such as frame tags, iframe tags, object tags, and embed tags. The frame defense layer (906) may be a nested frame blocking layer that blocks multiple different attempts to use an authorized frame with respect to the client web browser (902).

The form field defense layer (908) blocks attempts to directly copy or otherwise gain access to text entered into or received in forms. The form field defense layer (908) detects and blocks input value access, monitors network inputs and outputs to ensure that data is transmitted only to the desired internet protocol addresses, and monitors cookies to ensure that only legitimate cookies are in use.

The application security controller (900) may also present a honeypot surveillance network. In particular, the application security controller (900) generates decoy fake customers via the generation of browser sessions from server web browsers that are operated by scans (i.e., personas or behavior patterns). The application security controller (900) monitors the fake use the web service or web pages by the customers in order to identify whether malicious users are attempting to gain access to information via a client-side attack. Those assets of the web service and/or web page that have been the subject of attacks then can be provided with increased security via changing a security level of the assets.

Furthermore, the malicious users' attempts to attack the web service may be analyzed via the analysis engine (138) of FIG. 1 in order to further refine an attack surface map (see FIG. 11) and/or a threat model (see FIG. 12). In other words, the malicious user's attempts to perform a client-side attack may be used to further strengthen the protections provided by the application security controller (900).

Attention is now turned to FIG. 10. FIG. 10 shows an example of a threat model (1000). The threat model (1000) shows the relationships of various web pages with respect to a home domain (1002). Thus, for example, website (1004) may be accessed a particular URL that includes the home domain (1002) name. The threat model (1000) shows information about each individual web page or sub-domain at a glance. Thus for example, legend (1006) a number of scripts operable with respect to the website (1004), the number of identified vulnerabilities for the website (1004) (including their relative threat level), the number of trackers identified, and the countries from which the website (1004) has been accessed.

The threat model (1000) may be generated via use of the analysis engine (138) described with respect to FIG. 1, using the techniques described with respect to FIG. 2 through FIG. 8.

The analysis engine may use behavior patterns and server web browsers to autonomously replicate user actions on web applications and automatically simulate an attacker's reconnaissance, defense testing, and attack maneuvers to discover and map the organization's front-end attack surface. The analysis engine also classifies exposed data and prioritizes data exposure risks. The analysis engine may operate externally to the home domain, without any special privileges from the organization's web application in order to discover assets in the same manner as would a real malicious user. The analysis engine may probe installed libraries, utilize web service software, analyze the configuration of the website, and identify the security implementation flaws of each exposed data asset in the home domain and the sub-domains. The result of the analysis may be presented in a visual form as shown in the threat model (1000) of FIG. 10.

Additionally, FIG. 11 shows that the result of the analysis described above with respect to FIG. 10 may be further detailed in an attack surface report (1100). Thus, for example, findings and enumeration (1102) may be presented to show information useful for a security evaluation of the home domain.

The details of the most significant type of client-side vulnerabilities are presented as shown in section (1104). In the example of FIG. 11, the most significant type client-side vulnerability is that certain scripts are actively reading keystrokes.

Specific client-side vulnerabilities may be displayed in section (1106). In the example of FIG. 11, the number of vulnerabilities are displayed, along with the relative threat level, as classified by a machine learning model. The most vulnerable scripts are identified, along with additional information about the most vulnerable scripts.

In addition to the threat model (1000) of FIG. 10 and the attack surface report (1100) of FIG. 11, the analysis engine may also present conclusions and recommendations for taking additional security actions to improve the client-side security of a web service or website. While such conclusions and recommendations are not shown in the figures, different types of information may be presented in one or more conclusion and recommendation pages.

For example, a recommendation may be presented to review existing integrations and code supply chains to identify if and what third part code libraries and scripts are required on web pages with sensitive data (e.g., login pages, sign-up registrations, profile update forms, etc.). Specific such scripts may be identified, such as for example a “Get Started” pop-up registration form that is generated on the ACME.com home page. Other recommendations may include limiting access to sensitive data to only necessary JAVASCRIPT® scripts and libraries, to limit what third party code (e.g., ad pixels, GOOGLE® tag manager, etc.) can capture in order to minimize the risk of data exposure. Other recommendations may include to setup continuous monitoring from or in regulatory jurisdictions in which the company that hosts the home page is operating. Thus, the one or more embodiments may also be sued to assist a company to comply with applicable privacy regimes mandated by a regulatory jurisdiction. Other recommendations may include to setup alerting to identify changes in security controls or to identify potential exposures and/or loss of sensitive data due to a client-side vulnerability or misconfiguration. Many other different recommendations may be presented, including more general recommendations or more specific recommendations to those described above.

The one or more embodiments also may be used to assist with automatically remediating security threats identified using the one or more embodiments. Different aspects of a web service or a website may be remediated. Types of objects or services that may be remediated may include scripts and trackers, script activities, keylogging-like behavior, sniffing-like behavior, network access and data transfer, storage access (cookies, local storage, local and remote databases, etc.), script-side loading of other scripts, and script loading permissions. For example, scripts may be whitelisted or blacklisted, depending on the uniform resource link (URL) from which a script is loaded. Scripts may be detected and blocked before being injected into a web page on the server-side.

Frames may also be remediated. For example, frame loading permissions may be whitelisted or blacklisted, depending on the URL from which a frame is loaded. Thus, unauthorized frames may be blocked before being injected into a web page on the server-side.

User data access controls may also be remediated. For example, text, text areas, passwords, email addresses, etc., may be whitelisted or blacklisted, depending on the actor performing a particular action. Thus, any data access, read, write, and transmission command may be detected and blocked before the transmission occurs, unless authorized.

Still other forms of remediation are possible. For example, code execution may be adjusted or blocked in order to mitigate a client-side vulnerability, as described with respect to FIG. 1 through FIG. 8. For example, scripts and trackers may be detected and blocked before injected into a web-page loaded in a client web browser. In another example, the one or more embodiments may prevent dangerous eval-like code execution, including: eval( ) function, document.write( ), inline JAVASCRIPT® codes and tags, etc.

The one or more embodiments may also operate in an automatic and intelligent inline mode. For example, the one or more embodiments may use instrumentation techniques within a target page to proactively analyze any script inclusion or data read from the input form and make a decision to either block or allow the inclusion or data read. The decision may be performed using a machine learning model that classifies a request as legitimate or malicious. The machine learning model is trained based on the scans, described above, and thus perform such remediation actions in real-time.

In addition, a user may use a pre-configuration mode. In the pre-configuration mode, the user may explicitly configure the remediation module on how to behave in response to detecting a particular script or tracker.

In addition, the one or more embodiments provide for a dry-run mode. In the dry-run mode, the pre-configured or automatic configuration is executed but not enforced, and the remediation works only in dry-run mode. The dry-run mode allows rules to be emulated, but the final access mode will always be to allow an action.

Additional description is now provided with respect to data asset classification during analysis by a machine learning model, such as the machine learning model (160) described with respect to FIG. 1. Data asset classification takes place during ongoing of monitoring for client-side vulnerabilities while a webs service or website is in use.

Detection may be based on a trained machine learning multi-class model with LightGBM framework (e.g., gradient boosted decision trees). The features set may include English-like words extracted from a training set based on scans and field type. Thousands of features may be provided as input to the machine learning model. The features may be labeled in order to further improve the performance of the machine learning classification. During testing, the machine learning model reached about 96% classification accuracy.

Different feature extraction techniques may be used to generate automatically the machine learning model input vector during monitoring. Techniques include bag-of-words, set of words, set of word pairs, n-grams, and others. Labels may be automatically applied to labels using a dictionary of previously extracted features having previously determined labels. Thus, when an unknown feature matches a previously extracted feature, the previously determined label may be applied to the unknown feature.

Embodiments of the invention may be implemented on a computing system. Any combination of mobile, desktop, server, router, switch, embedded device, or other types of hardware may be used. For example, as shown in FIG. 12A, the computing system (1200) may include one or more computer processors (1202), non-persistent storage (1204) (e.g., volatile memory, such as random access memory (RAM), cache memory), persistent storage (1206) (e.g., a hard disk, an optical drive such as a compact disk (CD) drive or digital versatile disk (DVD) drive, a flash memory, etc.), a communication interface (1212) (e.g., Bluetooth interface, infrared interface, network interface, optical interface, etc.), and numerous other elements and functionalities.

The computer processor(s) (1202) may be an integrated circuit for processing instructions. For example, the computer processor(s) may be one or more cores or micro-cores of a processor. The computing system (1200) may also include one or more input devices (1210), such as a touchscreen, keyboard, mouse, microphone, touchpad, electronic pen, or any other type of input device.

The communication interface (1212) may include an integrated circuit for connecting the computing system (1200) to a network (not shown) (e.g., a local area network (LAN), a wide area network (WAN) such as the Internet, mobile network, or any other type of network) and/or to another device, such as another computing device.

Further, the computing system (1200) may include one or more output devices (1208), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (1202), non-persistent storage (1204), and persistent storage (1206). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (1200) in FIG. 12A may be connected to or be a part of a network. For example, as shown in FIG. 12B, the network (1220) may include multiple nodes (e.g., node X (1222), node Y (1224)). Each node may correspond to a computing system, such as the computing system shown in FIG. 12A, or a group of nodes combined may correspond to the computing system shown in FIG. 12A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (1200) may be located at a remote location and connected to the other elements over a network.

Although not shown in FIG. 12B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (1222), node Y (1224)) in the network (1220) may be configured to provide services for a client device (1226). For example, the nodes may be part of a cloud computing system. The nodes may include functionality to receive requests from the client device (1226) and transmit responses to the client device (1226). The client device (1226) may be a computing system, such as the computing system shown in FIG. 12A. Further, the client device (1226) may include and/or perform all or a portion of one or more embodiments of the invention.

The computing system or group of computing systems described in FIG. 12A and 12B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 12A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 12A, while performing one or more embodiments of the invention, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 12A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 12A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions present only a few examples of functions performed by the computing system of FIG. 12A and the nodes and/or client device in FIG. 12B. Other functions may be performed using one or more embodiments of the invention.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The term “about,” when used with respect to a computer or a computer-executed instruction, refers to a computer engineering tolerance anticipated or determined by a computer scientist or computer technician of ordinary skill in the art. The exact quantified degree of an engineering tolerance depends on the software and/or hardware in use and the technical property being measured. For a non-limiting example, two processes may be “about” concurrent when one process is executed within a pre-defined number of processor operations of the other process. In another non-limiting example in which an algorithm compares a first property to a second property, the first property may be “about” equal to the second property when the two properties are within a pre-determined range of measurement. Engineering tolerances could be loosened in other embodiments; i.e., outside of the above-mentioned pre-determined range in one embodiment, but inside another pre-determined range in another embodiment. In any case, the ordinary artisan is capable of assessing what is an acceptable engineering tolerance for a particular algorithm, process, or hardware arrangement, and thus is capable of assessing how to determine the variance of measurement contemplated by the term “about.”

As used herein, the terms “connected to” or “in communication with” contemplate multiple meanings. A connection or communication may be direct or indirect. For example, computer A may be directly connected to, or communicate with, computer B by means of a direct communication link. Computer A may be indirectly connected to, or communicate with, computer B by means of a common network environment to which both computers are connected. A connection or communication may be wired or wireless. A or connection or communication may be temporary, permanent, or semi-permanent communication channel between two entities.

As used herein, an entity is an electronic device, not necessarily limited to a computer. Thus, an entity may be a mobile phone, a smart watch, a laptop computer, a desktop computer, a server computer, etc. As used herein, the term “computer” is synonymous with the word “entity,” unless stated otherwise.

While the one or more embodiments have been described with respect to a limited number of embodiments, those skilled in the art, having benefit of this disclosure, will appreciate that other embodiments can be devised which do not depart from the scope of the one or more embodiments as disclosed herein. Accordingly, the scope of the one or more embodiments should be limited only by the attached claims.

What is claimed is:

1. A method comprising:
generating scan results by executing a scan by a server web browser, wherein:
the scan comprises a behavior pattern that defines a simulated use of the server web browser to access a web service,
executing the scan comprises causing the server web browser to access the web service according to the behavior pattern,
the scan results comprise monitoring information generated by monitoring execution of the scan;
detecting, using the scan results, a vulnerability of data accessed during the simulated use of the server web browser;
determining, responsive to detecting the vulnerability, an access mode for the data; and
applying the access mode to an attempt to access the data by the server web browser.

2. The method of claim 1, wherein the access mode comprises one of blocking access to the data and permitting access to the data.

3. The method of claim 1, wherein the data is provided by the server web browser to the web service, is provided by the web service to the server web browser, or a combination thereof.

4. The method of claim 1, wherein the access mode is specific to a script type of a script attempting to access the data, and wherein the access mode blocks execution of the script.

5. The method of claim 4, wherein the script type comprises at least one of a first party script, a third party script, an N^{th} party script, a first party tracker, a relationship between the script and the web service, and combinations thereof.

6. The method of claim 1, wherein the server web browser executes in a monitored environment, and wherein the method further comprises:
determining that the server web browser accesses the data using native code of the monitored environment; and
replacing the native code with modified native code comprising functionality to (i) observe an attempt to access the data, and (ii) comply with the access mode when an attempt to access the data is executed.

7. The method of claim 1, further comprising:
determining, using a machine learning model, an asset class of the data.

8. The method of claim 7, further comprising:
determining the access mode using the asset class and a script type of a script attempting to access the data.

9. The method of claim 1, further comprising:
detecting, using the scan results, malware in the data accessed by the server web browser.

10. The method of claim 9, further comprising:
generating, responsive to detecting the malware, a threat model; and
presenting the threat model in a graphical user interface (GUI).

11. The method of claim 10, wherein the threat model comprises a data flow corresponding to data used by the malware.

12. The method of claim 10, wherein presenting the threat model comprises at least one of:
presenting a data flow diagram of a data flow used by the malware; and
presenting an attack surface map corresponding to one or more portions of the server web browser targeted by the malware.

13. The method of claim 1, further comprising automatically remediating the server web browser by taking an action selected from at least one of:
presenting a list of mitigation recommendations against unauthorized data access,
presenting a change log describing a change in the server web browser,
setting a content security policy,
initiating tag control,
applying a compliance requirement to the server web browser, and
enabling disabling, pausing, or configuring a security setting.

14. A method comprising:
receiving, from a plurality of client applications comprising a plurality of client web browsers executing in a plurality of runtime environments, a plurality of requests to access or to transmit data to a web service;
generating a plurality of browser sessions for the plurality of client web browsers;
applying a plurality of security configurations to the plurality of browser sessions, wherein the plurality of security configurations includes a selected access mode applicable to a plurality of scripts executable by the plurality of client web browsers in the plurality of runtime environments;
monitoring for a call to execute, in a runtime environment of the plurality of runtime environments, a script of the plurality of scripts during a browser session of the plurality of browser sessions; and
securing the data by applying the selected access mode to the script before permitting the script to execute in the runtime environment.

15. The method of claim 14, wherein applying the plurality of security configurations comprises:
auto instrumenting a script analysis controller on web pages generated by the web service, and
applying, by the script analysis controller and for the web pages, the plurality of security configurations to the plurality of browser sessions.

16. The method of claim 15, wherein monitoring and securing are performed by the script analysis controller.

17. The method of claim 14, wherein the selected access mode comprises one of:
blocking execution of the script; and
allowing executing of the script.

18. The method of claim 14, wherein securing further comprises:
determining that a client application of the plurality of client applications calls native code of a runtime environment of the plurality of runtime environments; and
replacing the native code with modified native code comprising functionality to (i) observe an attempt to access the data as part of executing the script, and (ii) comply with the selected access mode when an attempt to access the data is executed during execution of the script.

19. A system comprising:
a server;
a repository in communication with the server and storing:
data comprising sensitive information,
a plurality of requests to access or to transmit the data to a web service, the plurality of requests received from a plurality of client applications comprising a plurality of client web browsers executing in a plurality of runtime environments, and
a plurality of security configurations applicable to a plurality of browser sessions generated for the plurality of client web browsers, wherein the plurality of security configurations comprise a selected access mode applicable to a plurality of scripts executable by the plurality of client web browsers in the plurality of runtime environments;
the web service, wherein the web service is executable by or in communication with the server, and is programmed to:
receive, from the plurality of client applications, the plurality of requests to access or to transmit the data to the web service, and
generate the plurality of browser sessions; and
a script analysis controller executable by the server and programmed to:
apply the plurality of security configurations to the plurality of browser sessions,
monitor for a call to execute, in a runtime environment of the plurality of runtime environments, a script of the plurality of scripts during a browser session of the plurality of browser sessions, and
secure the data by applying the selected access mode to the script before permitting the script to execute in the runtime environment.

20. The system of claim 19, wherein the script analysis controller is further configured to apply the selected access mode by performing one of:
blocking execution of the script; and
allowing execution of the script.
